(19) United States
(12) Patent Application Publication
(10) Pub. No.: US 2017/0053348 A1
(43) Pub. Date: Feb. 23, 2017

(54) Securities Trading and Pricing System and Method Using Obscured Indicia on Physical Objects

(71) Applicants: Charles O'Brien, Montreal (CA); Devinder O'Brien-Narang, Montreal (CA)

(72) Inventors: Charles O'Brien, Montreal (CA); Devinder O'Brien-Narang, Montreal (CA)

(21) Appl. No.: 14/829,282

(22) Filed: Aug. 18, 2015

(51) Int. Cl. G06Q 40/04

(52) U.S. Cl. CPC G06Q 40/04

(57) ABSTRACT

The present invention provides a system and method for facilitating trade of securities. One or a series of physical objects are provided to a deviner. Each physical object includes an indicia, which may be associated with a particular security, where the indicia may be obscured from the deviner. An impression is then received from the deviner which is indicative of a securities trading action, while the indicia of the particular security may remain obscured from the deviner. The indicia of the physical object is then identified. Subsequently, the impression is associated with the indicia and a further action is configured based on the association. The further action may be a trade recommendation for a particular security, or the selection of a further physical object which is provided to the deviner for a further impression. A series of impressions may thus be used to form a trade recommendation.

### CROSS-REFERENCE TO RELATED APPLICATIONS

This is the first application filed for the present invention.

### FIELD OF THE INVENTION

The present invention pertains to the field of securities trading and pricing and in particular to a method and system for facilitating securities trades and/or pricing and evaluation of same.

### BACKGROUND

Trading of securities such as stocks, bonds, derivatives, and the like, is a popular pastime and profession in various economies. However, it is notoriously difficult to identify profitable trade opportunities with a high degree of accuracy in such environments, due for example to the high competitiveness among traders, the nature of information in the marketplace, the tendency for knowledge of a security to be rapidly “priced in” to the market, and the like.

Securities trades may be performed as part of an economic activity, for amusement purposes, research purposes, or a combination thereof. Further, simulated securities trades in real or simulated market environments may be carried out for amusement or research purposes.

Securities trading includes a competitive element, in which individual traders wish to maximize their own performance. This results in an “arms race” situation in which traders devise new strategies in an attempt to out-do or even exploit one another. Consequently, as conventional approaches to identifying profitable trade opportunities are depleted, a need arises for alternative paradigms. Therefore there is a need for a trading and pricing system and method that differs from those of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a securities trading and pricing system and method using obscured indicia on physical objects, as well as associated evaluation systems and methods. In accordance with an aspect of the present invention, there is provided a system for facilitating trade of securities, the system comprising: a physical object comprising an indicia, the physical object for provision to a deviner; a trading module configured to: receive an impression from the deviner, wherein the impression is received while the physical object is in possession of the deviner; receive an identification of the indicia; associate the impression with the indicia; and configure a further action based on the impression in association with the indicia.

In accordance with another aspect of the present invention, there is provided a system for facilitating trade of securities, the system comprising: a set of physical objects for provision to a deviner, each of the set of physical objects comprising a respective indicia; a trading module configured to: receive an impression from the deviner, wherein the impression is received while a particular one of the set of physical objects is in possession of the deviner, and wherein the impression is associated with the particular one of the set of physical objects; receive an identification of the indicia of the particular one of the set of physical objects; associate the impression with the indicia; and configure a further action based on the impression in association with the indicia.

In accordance with another aspect of the present invention, there is provided a method for facilitating trade of securities, the method comprising: providing a physical object to a deviner, the physical object comprising an indicia; receiving an impression from the deviner, wherein the impression is received while the physical object is in possession of the deviner; receiving an identification of the indicia; associating the impression with the indicia; and configuring a further action based on the impression in association with the indicia.

In accordance with another aspect of the present invention, there is provided a method for facilitating trade of securities, the method comprising: selecting a particular object from a set of physical objects for provision to a deviner, each object of the set of physical objects comprising a respective indicia; upon provision of the particular object to the deviner: receiving an impression from the deviner while the particular object is in possession of the deviner, and wherein the impression is associated with the particular object; identifying the indicia of the particular object; associating the impression with the indicia; and configuring a further action based on the impression in association with the indicia.

### BRIEF DESCRIPTION OF THE FIGURES

FIG. 1 illustrates a method for facilitating trade of securities, for example including selection of a security to trade, in accordance with embodiments of the present invention.

FIG. 2 illustrates a system for facilitating trade of securities, for example including selection of a security to trade, in accordance with embodiments of the present invention.

FIG. 3 illustrates a process for selecting a numerical value to be used in association with a trade recommendation, for example to price a security to be traded, in accordance with embodiments of the present invention.

FIG. 4 illustrates a method for evaluating potential deviners, in accordance with an embodiment of the present invention.

FIG. 5 illustrates another aspect of a method for evaluating potential deviners, in accordance with an embodiment of the present invention.

### DETAILED DESCRIPTION OF THE INVENTION

### Definitions

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a system and method for facilitating trade and pricing of securities. In accordance with various embodiments of the invention, a set of one or more physical objects are provided, each comprising an indicia. The indicia may for example be associated with a particular security or with another trade parameter or set of trade parameters such as price, quantity, or the like. In various embodiments, the indicia may be obscured from a deviner to whom the physical objects are provided. For example, a physical object may be a folded piece of paper with a securities symbol or other information written, such as price and quantity, on an obscured part of its surface. When there are plural physical objects in the set, they may be substantially indistinguishable from each other from the point of view of the deviner, particularly if the indicia are obscured. The physical objects are provided, for example in a single batch provided all at once, or alternatively in a sequence of individual objects or a sequence of batches, to a deviner and an impression is received from the deviner for each particular security received. In some embodiments, the impression may be a relative impression. For example, the deviner may hold each object of a batch in turn, and assess and categorize their relative impression, such as a relative heat. In various embodiments, the impression may be indicative of a securities trading action, such as a “strong buy” “buy” “sell” or “strong sell” action or other action, and notably the impression is received, for example while the indicia of the particular security remains obscured from the deviner. This removes a critical knowledge component from the deviner while the impression is being formed. This may facilitate a different mode of decision making, that is based on factors other than knowledge of the indicia and reasoning flowing from such knowledge. The indicia of the associated physical object is analyzed, for example subsequently to receipt of the impression, to identify the particular security. Subsequently, the impression is associated with the particular security, for example by merging information of both the impression and the indicia. A further action is then configured based on the impression in association with the particular security. The further action may be a trade recommendation for that security, such as a buy or sell recommendation. In some embodiments, a trade may be executed based on the trade recommendation. In some embodiments, the trade recommendation may be recorded for example on a spreadsheet or in a diary, or the like.

In some embodiments, a series of physical objects may be provided to the deviner, wherein the deviner's impression related to a first physical object is used to influence selection of a subsequent physical object, and/or to influence selection of the indicia associated with the subsequent physical object. In this case a further action to be taken may correspond to the selection of the subsequent physical object. The deviner may form a series of impressions corresponding to the series of physical objects. This series of impressions may be associated with the trade recommendation for a given security or a set of securities. For example, the series of impressions taken together may imply a particular trade recommendation.

An assistant, either a person or a mechanical or computing mechanism may perform the selection of physical objects. Such an assistant may have access to the indicia in order to facilitate object selection, but refrains from communicating information regarding the indicia to the deviner. The selection of physical objects may be performed in a predetermined manner, for example based on a rule set. In some embodiments, a computing mechanism or mechanical device may physically embody the rule set by its operation.

In some embodiments, the physical object corresponds to an electronic device, such as a handheld electronic device or mobile phone, special-purpose electronic device, or the like. The electronic device may be configured, for example via a software application installed thereon, to manifest as a desired physical object at a desired time. For example, when it is desired to provide a particular physical object to the deviner, the electronic device may be configured with the indicia of that particular physical object. The act of configuration may correspond to provision of the physical object to the deviner. In some embodiments, a display screen of the electronic device may display a colored icon which is adjusted when the electronic device manifests different physical objects. As such, the electronic device may be used as multiple physical objects at different times, due to reconfiguration of the electronic device. In some embodiments, the deviner may retain possession of the electronic device which may be updated at different times to manifest different physical objects. The deviner may consider themselves to be provided with a series of different physical objects due to the updates. In some embodiments, the electronic device may be considered as the physical object, which may transform due to the updates. In some embodiments, an icon displayed by the electronic device may be considered to be the physical object.

In various embodiments of the present invention, securities may include debt securities such as bonds, equity securities such as stocks, derivative securities such as options or swaps, currencies, commodities or other tradable financial assets of perceived and/or intrinsic value, such as art, gems, automobiles, or the like.

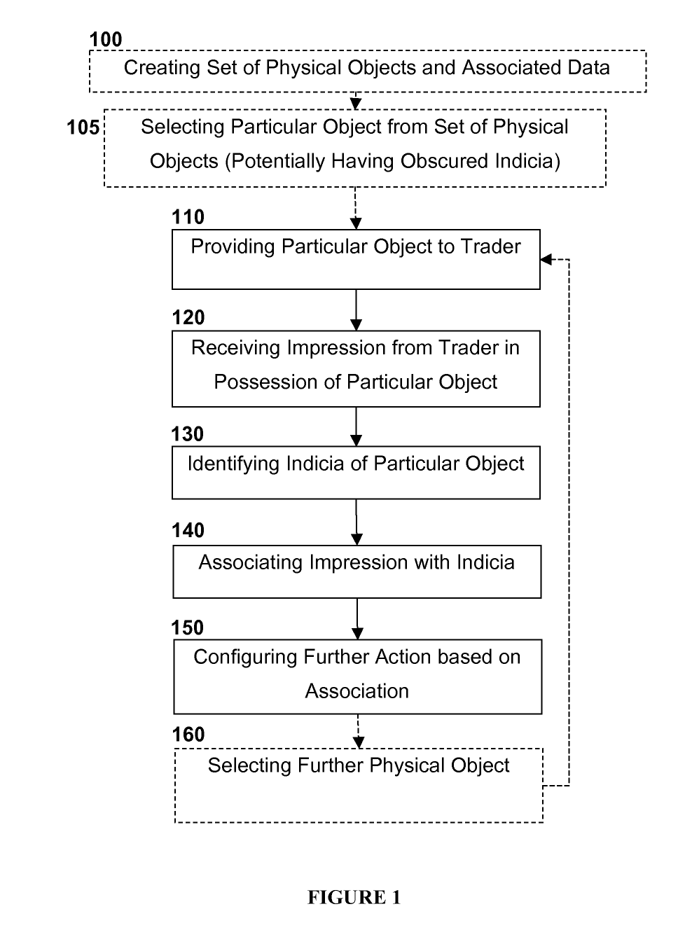

FIG. 1 illustrates a method for facilitating trade of securities, in accordance with embodiments of the present invention. The method optionally includes creating 100 a candidate set of physical objects and associated data. Alternatively, the set of objects may be considered to be given a priori. Creation of the candidate set of physical objects may include adding indicia to a stock of “blank” physical objects. The indicia may reflect obscured or obfuscated data such as securities data and corresponding parameters (such as the identity of the security, buy, sell, hold instructions, price, etc.), and may be in the form of a barcode or other obfuscated code, for example. The creation process may further comprise selecting which securities, parameter sets, or other phenomena are to be represented by physical objects and in which way. The created associated data may include a mapping between the information being represented by the physical objects and the indicia thereof, so that the indicia of a given physical object can later be decoded to determine the information represented thereby.

The method optionally includes selecting 105 a particular object from the set of physical objects. Alternatively a physical object may be provided without selection, for example when the set contains only a single such physical object. In either case, each object of the set of physical objects includes its own indicia, which in some embodiments is obscured from a deviner to whom the particular object will be provided. The method further includes physically providing 110 the selected particular object to the deviner, for example by delivering the object to the deviner's hands. The deviner then generates an impression in association with the physical object. The method includes receiving 120 the impression from the deviner while the particular object is in possession of the deviner and, in some embodiments, while the indicia of the particular object remains obscured from the deviner. The impression is associated with the particular object and may for example be an impression of hot or cold emanating from the particular object. The impression may be deemed as indicative of a particular securities trading action, for example with heat and cold indicative of relative bullishness or bearishness of the security, respectively.

The method further includes identifying 130 the indicia of the particular object. This may be performed by inspecting the particular object for the indicia thereof. This may be done for example automatically by a computer or machine or by an assistant to the deviner. Identification of the indicia is performed separately from formation of the deviner's impression, for example after the impression is formed, in order to correlate the impression with the indicia without affecting the deviner's formation of intuition in association with the physical object. The method further includes associating 140 the deviner's impression with the indicia. For example, a “hot” impression may be associated with the identity of a particular security designated by the indicia, and hence a “buy” recommendation for that security may be inferred. The method further includes configuring 150 a further action based on the impression in association with the indicia. For example, the further action may be to record a trade recommendation inferred from the association, to execute the corresponding trade, or the like.

Another type of further actions may include selecting 160 a further physical object, from the set of physical objects, for consideration by the deviner, and repeating the above-described method. As such, a trade recommendation may be derived from a series of iterations of the above-described method. Further, at least some of the iterations may form a part of a trade recommendation, such that an overall trade recommendation may be derived from the plural trade recommendation parts. For example, a series of impressions or iterations may be used to determine a quantity such as a price or volume associated with a trade of a given security. The series of impressions or iterations may involve presenting physical objects in which the indicia are numbers or are indicative of number values. For example, once a security is selected, various numbers may be given to the deviner, who is informed that only the hottest is of interest. If the hottest number is the highest or lowest number then that number and a new series of higher or lower numbers is provided to the deviner. In some embodiments, when the series of impressions is intended to determine pricing, the word “market” or “at market” or the like, may be one of the indicia.

Alternatively with respect to FIG. 1, a set of plural physical objects may be provided to a trader, one or more impressions may be received from the trader and then associated with the physical objects in the set in a predetermined manner, and one or more further actions may be configured.

As set forth above, securities trading in accordance with various embodiments of the invention may utilize a trader (a person), who is asked to execute trades based on trade recommendations given by the deviner, while certain information is potentially obscured or withheld from the deviner. In various embodiments, the deviner is given a physical object on which a security is identified, such as a piece of paper with a stock symbol written on it. However, the identity of the security may be hidden from the deviner, for example by folding the paper to obscure the stock symbol. The trader may therefore be separate from the deviner, but able to receive trade recommendations therefrom.

The deviner is asked to provide a trading impression based on a perception in relation to the received physical object. The perception may be, for example, a perception of heat or temperature of the physical object. For example, physical objects such as pieces of paper may be compared by perceived relative heat or temperature, with perceived hot objects being interpreted as corresponding to securities which should be bought and cold objects being interpreted as corresponding to securities which should not be bought and/or which should be sold. Gradations of hot and cold may be further indicative of relative bullishness or bearishness of the security, respectively. It is noted that the perception of heat or temperature, or the perception of another characteristic associated with the physical object, may not necessarily correlate with or have a reliable causal connection with actual corresponding characteristic of the object. Further, if such a correlation does exist, it may be due to heat generated by the deviner and potentially transferred to the physical object. Rather it is the deviner's perception of the characteristic that is used to drive the trade impressions. Indeed, in some but not necessarily all embodiments, efforts may be made to cause the physical objects to have common characteristics as much as possible, such as uniform temperature, prior to giving such objects to the deviner. In some embodiments, causal connection between actual characteristics of the object and diviner perceptions may be absent entirely, and such absence may be verified through statistical methods, if desired.

Other perceptions of the physical objects and used as the basis for trade impressions may include tactile perceptions such as a perceived amount of electrical energy carried by a physical object as it is held, or other types of tactile perception such as object roughness, thickness, or the like. It is also contemplated that non-tactile perceptions, such as visual or audible perceptions, may be utilized by deviners. Different deviners may exhibit different degrees of success when using different perceptions or combinations thereof. Perception may relate to a mental experience of the deviner, such as a mental experience which is interpreted as a sensory stimulation, potentially independently of whether the physical impetus corresponding to such a sensory stimulation is detectable by currently available instrumentation.

Some embodiments of the present invention therefore relate to a process for sorting a collection of physical objects, as follows. Each of the physical objects comprises an identifier of a particular security, the identifier being potentially obscured. The physical objects are initially located in an unsorted input collection and are assessed, typically one at a time, by the deviner. The deviner sorts collections, for example a “buy” collection designating objects comprising securities to be purchased and a “sell” collection designating objects comprising securities to be sold. Additional output collections may be present for example depending on the strength of the “buy” or “sell” impressions. Other impressions, such as “hold,” “buy or sell at a given price,” “adjust holdings to a particular number or value of securities,” “write or buy a particular put or call option,” or the like, may also be accepted.

Alternatively, the physical objects themselves need not necessarily be sorted, but rather the deviner's perceptions may be used to alter the state of a physical apparatus, such as a computer, used to direct execution of trades. For example, the deviner, or an assistant to the deviner, may record the deviner's “buy” or “sell” impression on paper or on a computer. The impressions are further associated with the identity of the security associated with the physical object which triggered the impression. The impression and associated security identity are viewed as a trade recommendation, for immediate or future execution. As will be readily understood, entering the recommendations in a computer causes a change in the physical, electronic state of the computer, such as volatile or non-volatile memory elements, pixels, and the like. Thus, the process physically manipulates the system of physical objects collectively with the physical medium via which the trade recommendations are recorded and/or implemented.

In addition to the physical objects comprising the security identifiers, and optionally the medium to record and/or execute the recommended trades, embodiments of the present invention may comprise other physical items. For example, the physical objects may be tokens which are movable on a board having designated locations corresponding to the input collection and plural output collections, or the tokens may be movable between a corresponding collection of bins. Such boards or bins may provide the process with the look and feel of a board game, for example. In one embodiment, the game may be entitled “Flash Card Boys” or the like.

In some embodiments, an apparatus may be provided which is capable of automatically recognizing and recording the security identifiers on the physical objects, for example by reading a barcode, performing optical character recognition on the identifiers, or the like. For example, the security identifiers may be flat plastic tokens each having a barcode located on its bottom face and obscured from the deviner. The deviner may deposit the tokens into appropriate slots of the apparatus, such as “buy” slots or “sell” slots, “strong buy” slots, strong sell slots, and “hold” slots, at which time the apparatus scans the barcode to recognize the security identifier thereon. The apparatus may be operatively coupled to a computer which records and/or executes the trade recommendation accordingly.

In some embodiments, rather than having the computer execute the trade recommendation, the computer may display or print out a summary of trade recommendations for a trader. The trader may then choose to act or not act upon the recommendations. Thus, in one embodiment, there may be up to three actors: a trader, an assistant, and a deviner. Further, the trader may influence the choices presented to the deviner, for example by selecting which physical objects having particular indicia are provided to the deviner. The trader may further define a mapping of information, such as trading information, to be represented by the indicia being presented to the deviner, so that recommendations can be later decoded. The assistant may be a person who handles physical objects or tokens, or a machine or automated game with which the deviner interacts, for example by receiving physical objects therefrom and providing impressions and/or recommendations thereto. The assistant may further execute a sequence of operations such as providing the physical objects to the deviner in a predetermined sequence.

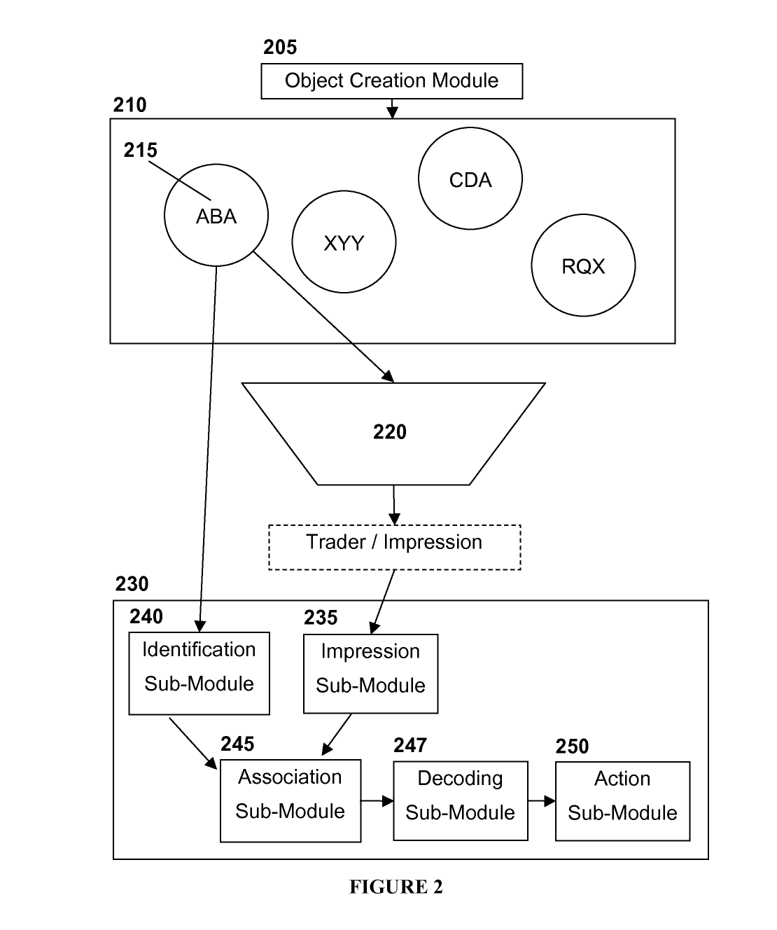

FIG. 2 illustrates a system for facilitating trade of securities, in accordance with embodiments of the present invention. The system comprises a set 210 of physical objects each comprising a respective indicia 215. In some embodiments, the indicia are obscured from a deviner to whom objects from the set of physical objects are to be provided. In some embodiments, the system comprises an object creation module 205, which is configured to add indicia to a stock of “blank” physical objects. The object creation module may further be configured to allow selection of which securities, parameter sets, or other phenomena are to be represented by indicia and in which way. The object creation module may further be configured to create a mapping between the information being represented by the indicia and the indicia itself, and to provide this mapping to a decoding sub-module 247.

The system may further comprise a mechanism 220 or means for selecting and providing physical objects from the set 210 to the deviner. The mechanism 220 may be mechanical in nature and physically manipulate and deliver physical objects. In some embodiments, the mechanism may be configured, in at least one mode of operation, to select physical objects substantially randomly. In some embodiments, the mechanism may be configured, in at least one mode of operation, to select physical objects having a particular desired indicia. To support the function of selecting particular physical objects for provision to the deviner, the mechanism may be configured to recognize objects having particular indicia, for example using one or more sensors. Alternatively, objects may be organized into locations based on the indicia thereof, and the mechanism may be configured to select objects based on location, thereby selecting particular physical objects for provision to the deviner.

The system further comprises a trading module 230 which may be a computer or mechanical device, and which includes an impression sub-module 235 configured to receive an impression from the deviner, wherein the impression is received while a particular one of the set of physical objects is in possession of the deviner, and wherein the impression is associated with the particular one of the set of physical objects. In some embodiments the indicia may remain obscured from the deviner while the set of physical objects is in their possession. Obscuring of the indicia may include obfuscation or encoding of the indicia. The impression sub-module may for example comprise a conventional computer input device for receiving and recording the impression via manual entry. The trading module further comprises an identification sub-module 240 configured to receive an identification of the indicia of the particular one of the set of physical objects. The identification sub-module may for example comprise a conventional computer input device for receiving and recording the indicia via manual entry or automatic entry. For example, a digital camera, barcode scanner, keypad, or the like, may be used for receiving the indicia.

The trading module further comprises an association sub-module 245 operatively coupled to the impression sub-module 235 and the identification sub-module 240 and configured to associate the impression with the indicia. The trading module further comprises an action sub-module 250 operatively coupled to the identification sub-module and configured to generate and/or configure a further action based on the impression in association with the indicia. The association sub-module and the action sub-module may for example be implemented as computing processes providing data output based on the received input corresponding to the impression and the indicia. A decoding sub-module 247 may also be provided, for example between the association sub-module and the action sub-module. The decoding sub-module may be configured to relate the impression associated with the indicia back to information related to a corresponding action to be taken, such as stock symbol, price, purchase recommendation. For example, the decoding sub-module may be configured to convert the obscured, obfuscated and/or encoded indicia back to information such as security identity, trade parameters, or other information represented by the indicia, or the like, using the mapping defined by the object creation module. In some embodiments, the deviner may be used to sort a plurality of physical objects based on relative impressions thereof. For example, the deviner may be used to sort the set of physical objects by perceived heat. In some embodiments, the deviner may be presented with a series of subsets of the physical objects, such as pairs of physical objects, and asked to indicate which object of the subset is hotter. By selecting appropriate subsets of physical objects to present to the deviner, the physical objects may be sorted in order of perceived heat. This may entail a series of comparisons, in which at least one physical object is compared pairwise against multiple other physical objects. Embodiments of the present invention may perform a series of selections of subsets of physical objects for example in accordance with various sorting algorithms, such as but not limited to a bubble sort, as would be readily understood by a worker skilled in the art. In various embodiments the mechanism 220 for selecting physical objects may be configured to perform a series of selections of physical objects in accordance with the sorting algorithm, and taking into account feedback received from the deviner via the impression sub-module.

In some embodiments, the indicia may indicate information relative to a trading decision, such as pricing information, timing information, trade volume, or the like, or a combination thereof. The indicia may further indicate a particular security to which the trading decision relates, or the identity of the particular security may be associated in another manner, and either revealed or not revealed to the deviner. For example, the security's identity may be associated with the last physical object previously handled by the deviner.

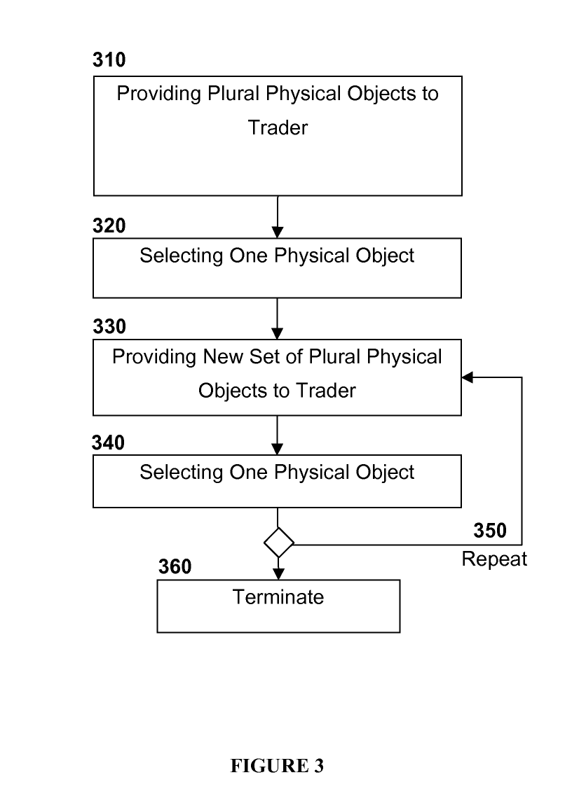

For example, as illustrated in FIG. 3, a number of physical objects having different indicia associated with different prices may be provided 310 to the deviner, and the deviner may be instructed to select 320 only one of the physical objects based on an impression, for example while the indicia are obscured. For example, four such objects may be given to the deviner. In one embodiment, if the deviner selects the object associated with the highest or lowest price indicia, then the process may be repeated by providing 330 a new set of objects, one of which has its indicia associated with the last selected price indicia, and the others having their indicia associated with higher prices (in the case that the highest price indicia was selected) or lower prices (in the case that the lowest price indicia was selected). The deviner is again instructed 340 to select only one of the physical objects based on an impression, for example while the indicia are obscured. The process may repeat 350 and may terminate 360 after a predetermined number of rounds or repeat until a stopping condition is reached, such as an object with neither the highest nor lowest price out of the current group being selected, or the object having the highest or lowest price indicia not being selected twice in a row, or the like.

As such, embodiments of the present invention provide for the execution of trade decisions of varying complexity by utilizing a deviner from whom certain critical information is withheld. Trade decisions may be made on the basis of one physical object or on the basis of multiple physical objects. The selection of future physical objects may be predicated on the deviner's impression with respect to one or more past physical objects.

In some embodiments, a series of actions based on impressions associated with physical objects and the indicia thereof may be performed in order to derive a trade recommendation. The actions may include a series of possibly interdependent actions for selecting physical objects and a set of trade recommendations.

In some embodiments, information may be made available to the deviner to influence the deviner's state of mind. The information may be true or false. In one embodiment, the deviner is told what type of decision is being made, such as a stock buying decision, possibly along with certain parameters or contextualizing information. The deviner may keep this information in mind while forming their impression associated with physical objects. In some embodiments, the deviner may be substantially fully aware of the type and context of the decision being made, save for a limited amount of critical information, such as an identity of the security, a price, or the like.

In various embodiments, information provided to the deviner may provide context for the resultant trade recommendation. For example, if the deviner is told a price, quantity, and market conditions, and then given a physical object comprising an indicia of a particular security, a “buy” or “sell” trade recommendation may be interpreted as a trade recommendation peculiar to the indicated price, quantity, and market conditions.

In some embodiments, similar issues brought to the deviner may be separated by at least a predetermined time interval. For example, if a particular physical object is provided to the deviner at a first time in association with seeking a trade recommendation, then that particular physical object and trade recommendation may be barred from being brought forward to the deviner again until the predetermined time interval has elapsed. This avoids raising the same issue multiple times in rapid succession. In some embodiments, the time interval may be shortened if a substantial change in market conditions occurs.

### Evaluation of Deviners

Some embodiments of the present invention relate to methods and systems for evaluating a given deviner's ability to execute the above-mentioned trading methods and systems. As is noted above, various trade impressions are provided by the deviner based on a perception of the deviner. Further, some persons may be more successful in executing advantageous trades than others, and indeed some persons may be completely unsuccessful. Therefore embodiments of the present invention comprise statistical tests for determining whether a given deviner's abilities are appreciable.

For example, in some embodiments, a deviner's observed performance is statistically evaluated with respect to a null hypothesis and an alternative hypothesis. The null hypothesis is that the deviner's performance is no better than random chance, i.e. the success level of trades made according to the resultant trade recommendations could be adequately explained by luck. The alternative hypothesis may be that the null hypothesis is false. Various statistical tests may be employed to determine, with a certain confidence level, whether the null or alternative hypothesis is true. Deviners for which the alternative hypothesis is observed to be true with a predetermined confidence level may be retained for further trading actions.

In various embodiments, potential deviners are humans. In other embodiments, potential deviners are animals, such as apes, birds, octopi, or other animals. Animals may be trained to accept physical objects and perform behaviours which can be interpreted as being indicative of impressions. In other embodiments, potential deviners may be machines, such as computers, or computers programmed in a particular way. The machines may be provided with input corresponding to a physical object and generate output which can be interpreted as being indicative of impressions. Computers operating in this manner may utilize non-deterministic algorithms, or may be trained from data sets using Recurrent Neural Network models of Deep Learning methodologies, for example. It is noted that, for non-human deviners, there may be no need to obscure the indicia on the physical objects.

Embodiments of the present invention relate to a system and method for identifying effective deviners. In some embodiments, a potential deviner may be subjected to a simulated version of the method and/or system for trading of securities as described elsewhere herein. The degree of success of the deviner in the simulation may be taken as indicative of the deviner's talents. In various embodiments, simulated data such as historical market data may be used as market data for the simulation. In some embodiments, the deviner may be told that the data is simulated, whereas in other embodiments the deviner may not be told that the data is simulated. In some embodiments, potential deviners are invited to play a board game or competitive online game that corresponds to a simulated version of the method and/or system for trading of securities as described elsewhere herein. Potential deviners who show a certain level of skill in the game may be invited to further participate as deviners in accordance with the method and/or system as described elsewhere herein.

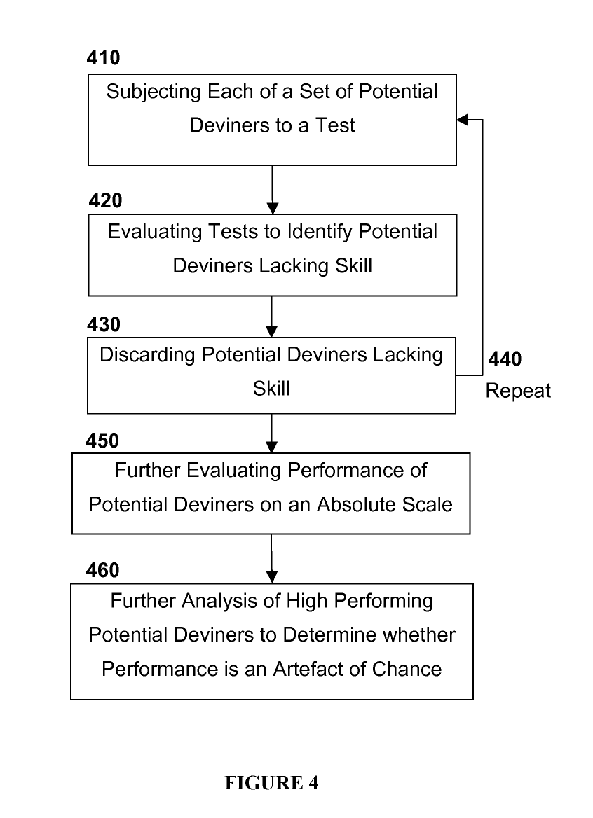

FIG. 4 illustrates a method for evaluating deviners, in accordance with an embodiment of the present invention. The method comprises subjecting 410 each of a set of potential deviners to a test, evaluating 420 the tests to identify potential deviners who appear to lack sufficient divination skill, discarding 430 those who are identified as lacking sufficient divination skill, and optionally repeating 440 the test and evaluation steps a desired number of times to further refine the set of potential deviners. At each stage, the test may be, for example, a simulated trading situation based on historical market data, in which performance of the potential deviners is evaluated with respect to their ability to recommend what would have been profitable trades under the historical conditions.

Following a certain number of rounds, the method may produce a limited set of potential deviners who have exhibited sufficient skill for further consideration. In some embodiments, the method further comprises evaluating 450 performance of at least the limited set of potential deviners on an absolute scale, rather than on a “curve” relative to other deviners. Potential deviners who do not exhibit a certain fixed level of ability, such as a certain average net profit percentage from simulated trades, may be discarded.

In some embodiments, noting that given enough potential deviners, there is a high likelihood of at least one person exhibiting a considerable degree of talent, purely by chance, the method may comprise further testing and/or analysis 460 of high-performing potential deviners to determine whether or not their performance is, within a reasonable likelihood, explainable as an artefact of chance. Further testing may be performed until this question is settled with a predetermined degree of confidence, for example using statistical methods.

In various embodiments, evaluation of potential deviners may be used to identify deviners with relative potential such as strong potential, weak potential, or the like. An experimental study may be implemented to systematically identify deviners exhibiting at least a desired threshold level of success. Multiple rounds of testing may be implemented with a select group of more successful deviners moving on from one round to the next. Deviners with stronger potential may be deemed as being potentially more successful in recommending profitable trades, for example.

FIG. 5 illustrates a Venn diagram showing criteria for evaluating potential deviners, in accordance with an embodiment of the present invention. Three regions corresponding to characteristics of potential deviners are illustrated, namely genetic predisposition 510 for example as indicated through family history or genetic typing, presence of a self-defence or survival instinct 520, and attentiveness 530. An individual possessing all three of these characteristics, that is falling within the intersection 550 of all three regions 510, 520 530, may exhibit sufficient intuition be considered to be a good deviner candidate. Meta-Evaluation

Some embodiments of the present invention relate to methods and systems for meta-evaluation of the above methods and systems for evaluating a given deviner's ability to execute the above-mentioned trading methods and systems. For example, it is recognized that if a sufficiently large number of deviners are evaluated, some of the deviners may, purely by chance, exhibit a very successful track record. In some embodiments, therefore, it is desired to know whether a successful track record is due to ability or chance. This may be indicative for example of whether a deviner's past performance is predictive of future performance. In some embodiments, correlation between past performance and future performance may be assumed, for example under the rationale that performance is time invariant.

Some embodiments of the present invention relate to a game and/or are provided for entertainment or amusement purposes. For example, one or more persons may implement the securities trading methods and systems, the evaluation methods and systems, and/or the meta-evaluation methods and systems primarily for purposes of entertainment or amusement, game competition, or the like. In some such embodiments, securities trades made for this purpose are simulated trades rather than real trades—that is, a simulated securities position may be taken without actually purchasing or selling the real security. The value evolution of such securities may be based on a market model or historical market data. Alternatively, the value evolution of such securities may be based on real market data as it evolves in time. In other such embodiments, securities trades are real trades, involving real money. Again the value evolution of such securities may be based on a market model, historical market data, or real-time market data. Thus, in some embodiments the securities trades may correspond to real trades made in real time, which may provide for an entertaining experience for individuals having the appropriate appetite for risk.

Some embodiments of the present invention may be configured to re-focus the deviner's attention by obscuring critical information from the deviner. For example, when the deviner is asked to make a trade decision on a security without knowing the identity of the security, their attention may turn to other factors, such as trade volumes, prices, trends, overall market conditions, and the like. This effect may be in addition to or alternatively to impressions associated with physical objects as described elsewhere herein. Embodiments of the present invention may therefore allow the deviner to consider trading activities in a new light, which may build insight, skill and/or experience of the deviner, for example by encouraging the formation of new neural connections for the deviner.

Moreover, when evaluating a deviner's abilities or performing a meta-evaluation of deviner evaluation approaches, it is recognized that a deviner's level of success under certain conditions, such as simulated trading conditions, may not be fully predictive of success levels under other conditions, such as real trading conditions. For example, a real trade of a security may impact the future price evolution that security and other securities, particularly if the trade is for a large number of the securities. Therefore, some embodiments of the present invention comprise regarding an evaluation and/or meta-evaluation as being relevant primarily to the conditions under which the trades are made. The evaluation and/or meta-evaluation may be regarded as being relevant to other conditions, but possibly with a discounted amount of relevance. For example, to evaluate a deviner's perceived performance in executing real trades in real-time market conditions, some embodiments observe the deviner's performance under those same conditions for a period of time.

Various evaluation and meta-evaluation processes as described herein comprise the sorting of deviners into distinct groups—for example those with apparent talent for executing advantageous trades and those without. Alternatively, deviners may be sorted on a spectrum indicating levels of apparent talent. Such a sorting may be recorded on a physical device, such as a computer. Additionally or alternatively, such a sorting may be used to physically remove some deviners from the trading activity area if they do not exhibit sufficient apparent talent.

### Deviner Classification

In various embodiments, deviners may be viewed for practical purposes as deviners, i.e. individual persons with special predictive powers. A convention for characterizing deviners may be utilized as follows. Some deviners may be created or become more apt in their abilities, while others have substantially no capacity to become deviners. Further, deviners may exhibit one or a combination of the following characteristics, which may be correlative with their predictive abilities. Some deviners may appear to have inherited or inheritable abilities, so that family members may have a higher likelihood of also having such abilities. In some embodiments, younger individuals may be considered more likely to be deviners, possibly since the abilities have not yet been socialized out. In some embodiments, introversion may be regarded as an indicator of divination ability. In some embodiments, electricity may be viewed as a strong indicator of divination ability. In some cases, trauma, violence or stress may be associated with divination ability, on the premise that such abilities arise as a defense mechanism. In some embodiments, gender may be correlated with divination ability, particularly the feminine gender. In some embodiments an indicator of human or animal intuition or divination ability is experienced as a sensation of heat, a current or of energy, for example akin to low grade electricity, or a mild electrical sensation. This sensation may be perceived as being controlled by and/or emanating from the intuitive person or deviner.

In some embodiments, a person in physical contact with a deviner may be deemed to also be a deviner. The hypothesis in this case may be that divination energy flows from the deviner through the person through physical contact.

Embodiments of the present invention therefore comprise evaluating a deviner based on a convention comprising one or more criteria, and utilizing highly evaluated deviners in the system and/or method as described elsewhere herein. A system for evaluating a deviner may comprise or be associated with the system for facilitating trade of securities as described elsewhere herein. The system may further comprise an evaluation module configured to record a history of associations between impressions and actions as generated by the deviner, and to analyze the history of associations to evaluate abilities of the deviner. The evaluation module may be implemented using a computer, for example.

In various embodiments, the term “intuition” as a property of a deviner may refer to the capacity to perceive and integrate sub-liminal cues in order to produce a decision. Further, in various embodiments of the present invention, the term “intuition” may refer to the ability to make a decision or perform an action based on an artifact other than conscious reasoning. For example, in the case of human or animal deviners, intuition may be based on instinct or feeling. In the case of machine deviners, intuition may be an inherent property of machine operation. A deviner may then provide an impression in relation to a physical object based on such intuition. Intuition as used herein may correspond to a measure of divination ability. Intuition may be considered reliable if it results in desirable outcomes, for example reliably profitable trade decisions, at least on average. In some embodiments, by obscuring certain facts from the deviner, the deviner is pushed toward a reliance on intuition rather than conscious reasoning. Thus, the indicia of a physical object may be obscured or obfuscated from the deviner while an impression is made by the deviner.

In some embodiments, the diviner gains insight into the trade-worthiness of a proposed action without conscious recourse to physical phenomena. By increasing sensory acuity over time and experience to ever smaller stimuli, the diviner may develop their intuitive sensibility to stimuli below the level of conscious awareness and accesses inner, unconscious experience to form impressions and produce decisions.

Embodiments of the present invention may be adjusted to accommodate different degrees of deviner intuition. For example, some deviners may be capable of reliably sorting a set of N objects based on their intuition, where the value of N depends on a particular deviner's talent. However, conventional sorting algorithms may be used to sort M>N objects by presenting a series of subsets of the M objects to the deviner at a time, each subset containing at most N objects.

Some embodiments of the present invention may comprise a game which is presented to be played by young individuals, in order to foster their potential divination abilities.

Embodiments of the present invention may be distinguished from certain methods that use a divining implement such as a pendulum to make decisions. Typically, a pendulum acts in a certain way which is then observed by a user in order to make a decision. The observation of the pendulum's physical action is an objectively measurable and repeatable observation of physical attributes, regardless of whether or not the user is subconsciously manipulating the pendulum. In contrast, embodiments of the present invention involve an impression or sensation which is based on a perception of a physical attribute of a physical object, such as a perception of hot or cold, that perception being substantially uncorrelated with and/or causally disconnected from objectively measurable physical attributes of the physical object.

Embodiments of the present invention may be distinguished from certain methods that form mental impressions rather than an impression or physical sensation which is based on a perception of a physical attribute of a physical object, such as a perception of hot or cold, but which may not be correlated with objectively measurable physical attributes of the physical object. For example, holding an object and forming a mental image or a prediction regarding the entity (such as a company) that is represented by the object differs from receiving a perception of physical attributes of the object itself.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A system for facilitating trade of securities, the system comprising:
a. one or more physical objects, each one of the one or more physical objects comprising an identifying indicia which is unique to said one of the one or more physical objects, the one or more physical objects for provision to a deviner;
b. a trading apparatus that:
i. generates a set of information items, each member of the set of information items to be represented by a respective one of the one or more physical objects;
ii. generates a mapping between members of the set of information items and corresponding ones of the identifying indicia of the physical objects;
iii. presents each of the one or more physical objects to the deviner;
iv. for each presented physical object of the one or more physical objects:
receives and records a determination from the deviner, wherein the determination is received while the presented physical object is in possession of the deviner and the indicia is obscured from the deviner;
identifies the indicia of the presented physical object;
associates the determination with the identified indicia of the presented physical object; and
associates the determination with a particular information item belonging to the set of information items, the particular information item corresponding to the identified indicia via the mapping; and
v. configures a further action based on the associations between the determinations and the information items.

2. (canceled)

3. The system of claim 1, wherein the further action is a securities trading action.

4. The system of claim 1, wherein the further action comprises forming a trade recommendation, and the trading apparatus further records, executes, or records and executes the trade recommendation.

5. The system of claim 1, wherein the further action comprises selecting a further physical object for consideration by the deviner.

6. The system of claim 1, further comprising at least two physical objects for provision to the deviner, the at least two physical objects being indistinguishable with respect to one or more physical aspects, said at least two physical objects comprising different indicia associated with different securities.

7. The system of claim 1, wherein each of the information items is indicative of one or more of a particular security, a trading price, a timing of a trading transaction, or a trade volume.

8. (canceled)

9. The system of claim 1, wherein the deviner is a human, an animal, or a machine.

10.-12. (canceled)

13. A method for facilitating trade of securities, the method comprising:
providing one or more physical objects, each one of the one or more physical objects comprising an identifying indicia which is unique to said one of the one or more physical objects;
generating a set of information items, each member of the set of information items to be represented by a respective one of the one or more physical objects;
generating a mapping between members of the set of information items and corresponding ones of the identifying indicia of the physical objects;
presenting each of the one or more physical objects to a deviner;
for each presented physical object of the one or more physical objects:
receiving and recording a determination from the deviner, wherein the determination is received while the physical object is in possession of the deviner and the indicia is obscured from the deviner;
identifying the indicia of the presented physical object;
associating the determination with the identified indicia of the presented physical object; and
associating the determination with a particular information item belonging to the set of information items, the particular information item corresponding to the identified indicia via the mapping; and
configuring a further action based on the associations between the determinations and the information items.

14. (canceled)

15. The method of claim 13, wherein the further action is a securities trading action.

16. The method of claim 13, wherein the further action comprises forming a trade recommendation, the method further comprising recording, executing, or recording and executing the trade recommendation.

17. The method of claim 13, wherein the further action comprises selecting a further physical object for consideration by the deviner.

18. The method of claim 13, further comprising providing at least two physical objects to the deviner, wherein the at least two physical objects are indistinguishable with respect to one or more physical aspects, said at least two physical objects comprising different indicia associated with different securities.

19. The method of claim 13, wherein each of the information items is indicative of one or more of a particular security, a trading price, a timing of a trading transaction, or a trade volume.

20.-22. (canceled)

23. The system of claim 1, wherein the one or more physical objects are pieces of paper or tokens, and wherein each of the one or more physical objects has said identifying indicia marked thereon.

24. The system of claim 1, wherein the one or more physical objects are electronic devices each having a display screen, and wherein each of the one or more physical objects has said identifying indicia displayed on said display screen.

25. The system of claim 1, wherein the one or more physical objects are presented to the deviner in a batch, in sequence, or in a sequence of batches.

26. The system of claim 1, wherein the determination from the deviner that is received and recorded includes an indication of impression from the deviner.

27. The system of claim 1, further comprising a board having designated locations corresponding to potential determinations, wherein the one or more physical objects are tokens which are movable on the board, and wherein the trading apparatus receiving the determination includes the trading apparatus observing actions of the deviner in moving the tokens on the board.

28. The system of claim 1, wherein the one or more physical objects include a plurality of physical objects, wherein the trading apparatus further receives a series of determinations from the deviner in association with the plurality of physical objects presented in series, and wherein the series of determinations is indicative, in order, of: an identification of a particular security; a trading price of the particular security; a trade volume of the particular security; and timing information for trading the particular security.

29. The method of claim 13, wherein the one or more physical objects are pieces of paper or tokens, and wherein each of the one or more physical objects has said identifying indicia marked thereon.

30. The method of claim 13, wherein the one or more physical objects are electronic devices each having a display screen, and wherein each of the one or more physical objects has said identifying indicia displayed on said display screen.

31. The method of claim 13, wherein the one or more physical objects are presented to the deviner in a batch, in sequence, or in a sequence of batches.

32. The method of claim 13, wherein the determination from the deviner that is received and recorded includes an indication of impression from the deviner.

33. The method of claim 13, wherein the one or more physical objects are tokens which are movable on a board having designated locations corresponding to potential determinations, and wherein receiving the determination includes observing actions of the deviner in moving the tokens on the board.

34. The method of claim 13, wherein the one or more physical objects include a plurality of physical objects, the method further comprising receiving a series of determinations from the deviner in association with the plurality of physical objects presented in series, and wherein the series of determinations is indicative, in order, of: an identification of a particular security; a trading price of the particular security; a trade volume of the particular security; and timing information for trading the particular security.
